(19) United States
(12) Patent Application Publication
(10) Pub. No.: US 2010/0250346 A1
(43) Pub. Date: Sep. 30, 2010

(54) USING V2X IN-NETWORK MESSAGE DISTRIBUTION AND PROCESSING PROTOCOLS TO ENABLE GEO-SERVICE ADVERTISEMENT APPLICATIONS

(75) Inventors: Fan Bai, Ann Arbor, MI (US); Donald K. Grimm, Utica, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/415,756

(22) Filed: Mar. 31, 2009

(51) Int. Cl. G06Q 30/00; H04H 20/71; G06Q 50/00

(52) U.S. Cl. 705/14.1; 705/14.62; 455/3.06

(57) ABSTRACT

A system and method for providing geo-service advertising messages using a wireless vehicle-to-infrastructure (V2X) communications network. Messages are transmitted from a business that identify the type of business, the name of the business and the location of the business, which are received by vehicles traveling within a certain distance of the business. The messages can be rebroadcast by the vehicles receiving the messages from the business to other vehicles either in a multi-hop information routing manner or in a delay-tolerant network information dissemination fashion so that the messages are sent to a wider area, but within a predetermined geographic area and with a predetermined time. If a particular user of the system wishes to learn about a particular business or type of business, he can activate the system so that the messages being sent between the vehicles and from the businesses can be displayed to the user for his use.

### BACKGROUND OF THE INVENTION

1. Field of the Invention

This invention relates generally to a system and method for broadcasting advertising messages from businesses to and between vehicles and, more particularly, to a system and method for broadcasting advertising messages from businesses to and between vehicles using vehicle-to-vehicle and vehicle-to-infrastructure (V2X) in-network message distribution and processing protocols.

2. Discussion of the Related Art

Traffic accidents and roadway congestion are significant problems for vehicle travel. Vehicular ad-hoc network (VANET) based active safety and driver assistance systems are known that allow a vehicle communications system to transmit messages to other vehicles in a particular area with warning messages about dangerous road conditions, driving events, accidents, etc. In these systems, multi-hop geocast routing protocols, known to those skilled in the art, are commonly used to extend the reachability of the warning messages, i.e., to deliver active messages to vehicles that may be a few kilometers away from the road condition, as a one-time multi-hop transmission process. In other words, an initial message advising drivers of a potential hazardous road condition is transmitted from vehicle to vehicle using the geocast routing protocol so that vehicles a significant distance away will receive the messages because one vehicle's transmission range is typically relatively short.

Vehicular ad-hoc network based active safety and driver assistance systems allow a wireless vehicle communications system, such as a dedicated short range communication (DSRC) system, known to those skilled in the art, to transmit messages to other vehicles in a particular area with warning messages about driving conditions. In these systems, multi-hop geocast routing protocols, known to those skilled in the art, are commonly used to extend the reachability of the warning messages, i.e., to deliver active messages to vehicles that may be a few kilometers away, as a one-time multi-hop transmission process. In other words, an initial message advising drivers of a certain situation is transmitted from vehicle to vehicle using the geocast routing protocol so that relevant vehicles a significant distance away will receive the messages where one vehicle's direct transmission range is typically relatively short

Vehicle-to-vehicle (V2V) and vehicle-to-infrastructure (V2X) applications require a minimum of one entity to send information to another entity. For example, many vehicle-to-vehicle safety applications can be executed on one vehicle by simply receiving broadcast messages from a neighboring vehicle. These messages are not directed to any specific vehicle, but are meant to be shared with a vehicle population to support the safety application. In these types of applications where collision avoidance is desirable, as two or more vehicles talk to each other and a collision becomes probable, the vehicle systems can warn the vehicle drivers, or possibly take evasive action for the driver, such as applying the brakes. Likewise, traffic control units can observe the broadcast of information and generate statistics on traffic flow through a given intersection or roadway.

The vehicle ad-hoc network communication systems discussed above have almost exclusively been used for safety applications. However, those systems can be extended to other applications, including non-safety applications.

### SUMMARY OF THE INVENTION

In accordance with the teachings of the present invention, a system and method are disclosed for providing geo-service advertising messages using a wireless vehicle-to-infrastructure (V2X) communications network. Messages are transmitted from a business that identify the type of business, the name of the business and the location of the business, which are received by vehicles traveling within a certain distance of the business. The messages can be rebroadcast by the vehicles receiving the messages from the business to other vehicles either in a multi-hop information routing manner or in a delay-tolerant network information dissemination fashion so that the messages are sent to a wider area, but within a predetermined geographic area and with a predetermined time. If a particular user of the system wishes to learn about a particular business or type of business, he can activate the system so that the messages being sent between the vehicles and from the businesses can be displayed to the user for his use.

Additional features of the present invention will become apparent from the following description and appended claims, taken in conjunction with the accompanying drawings.

### BRIEF DESCRIPTION OF THE DRAWINGS

FIG. 1 is a plan view of a vehicle including various systems and devices for providing geo-service advertisement transmissions;

FIG. 2 is a plan view of a roadway grid showing vehicles traveling on the roadways where messages are sent from businesses to the vehicles and between the vehicles; and

FIG. 3 is a plan view of a roadway grid showing a vehicle traveling on the grid and transferring messages about a business to other vehicles.

### DETAILED DESCRIPTION OF THE EMBODIMENTS

The following discussion of the embodiments of the invention directed to a system and method for broadcasting advertising messages in a V2X communications system is merely exemplary in nature, and is in no way intended to limit the invention or its applications or uses.

As will be discussed in detail below, the present invention proposes a system and method for employing V2X communications protocols for a non-safety application where advertisement messages are transmitted from businesses and are routed to vehicles therefrom in a vehicular ad-hoc network by intelligently exploiting inherent vehicle mobility and wireless communications.

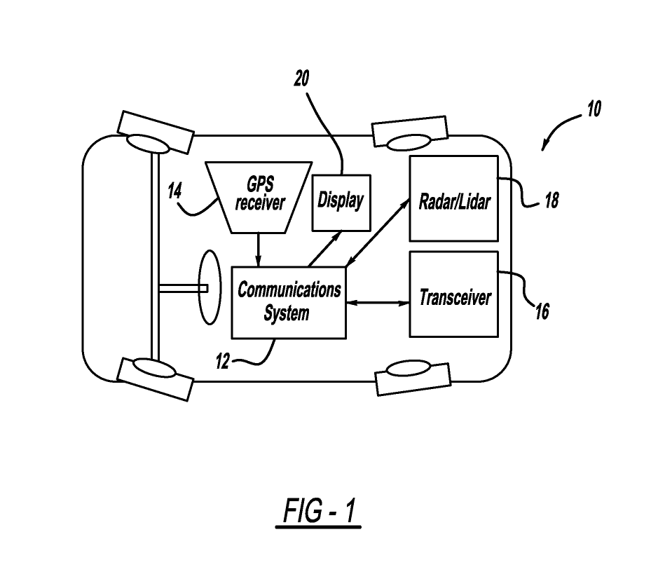

FIG. 1 is a representation of a vehicle 10 that includes a communications system 12, a GPS receiver 14, a transceiver 16, a lidar, radar, vision and/or other sensing devices 18 and a display 20 that may be used in a vehicular ad-hoc communications network for advertising purposes, as discussed herein. The communications system 12 can be any suitable wireless vehicle communication system for the purposes discussed herein, such as the known DSRC system.

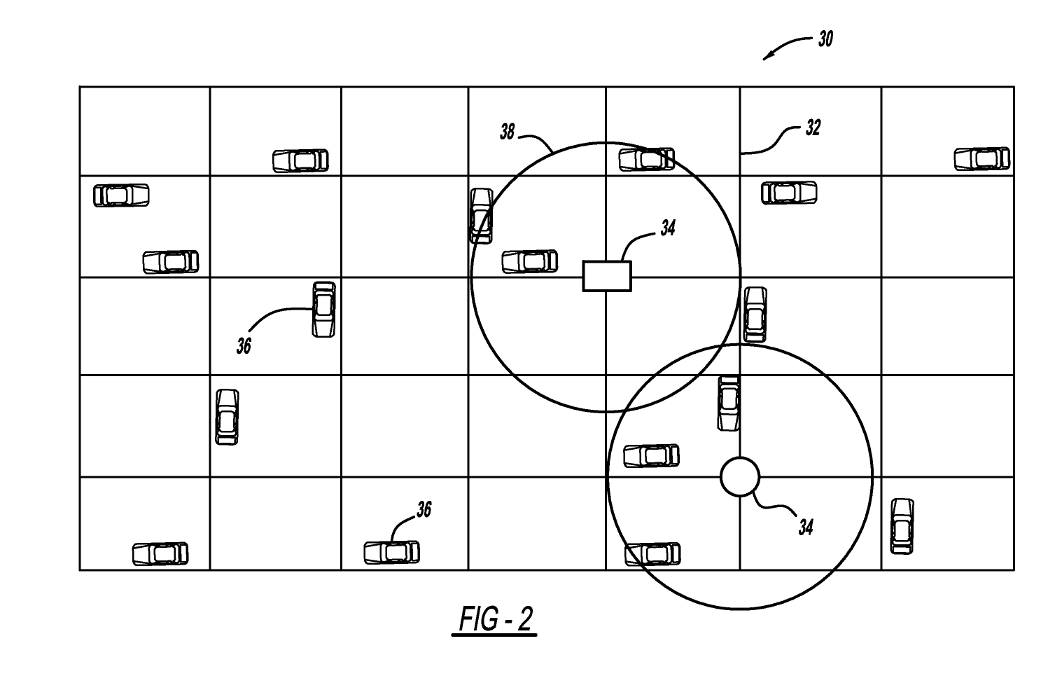

FIG. 2 is a plan view of a roadway grid 30 including roadways 32. Various businesses 34 are interspersed among the grid 30 along the roadways 32. Vehicles 36 traveling along the roadways 32 are able to wirelessly broadcast messages to each other in an ad-hoc manner using their communications system 12, in a manner that is well understood to those skilled in the art. The businesses 34 can be any business that desires to advertise to motorists or pedestrians traveling in its area, such as restaurants, banks, florists, grocers, etc. The businesses 34 will include a DSRC type broadcasting unit that broadcasts messages to the vehicles 36 within some range, such as 5 km, around the business 34, as identified by circles 38, that is received by the vehicles 36 that have their own DSRC communications unit as part of the system 12. The messages identify the time the message was sent, the type and name of the business and its location. The message that is received by a particular vehicle 36 within that range can then be retransmitted by the vehicle 36 to other vehicles 36 outside of the range of the transmission of the message from the business 34 in a multi-hop fashion. The message can be rebroadcast by the vehicles 36 as long as a particular vehicle 36 is within some targeted area.

As mentioned above, the vehicles 36 that receive the messages from the business 34 can then rebroadcast it to other vehicles 36 that it encounters within a certain distance of the business 34. The message transfer between the vehicles 36 and from the business 34 to the vehicles 36 that include the communications system 12 continuously occurs and is received and transmitted by the vehicles 36 at the application level of the protocol of the system 12. Then, when a particular vehicle occupant wishes to learn about a particular business or type of business, he can activate the system 12 at the user level to look for a particular business, such as a restaurant, which can then be brought up on the display 20. The message may contain a service type, the time of the message transmission and location of the business 34. The message may also include temporal and spatial constraints for potential recipients, particularly the vehicles 36. The message may also include a coupon as an incentive to cause people who receive the message to enter the business 36 to receive some value. The message can be distributed by the vehicles 36 in a multi-hop dissemination protocol to distribute geo-service advertisement messages to potential recipients. In this protocol, each vehicle broadcasts the received message as long as the vehicle is within a specific targeted spatial range.

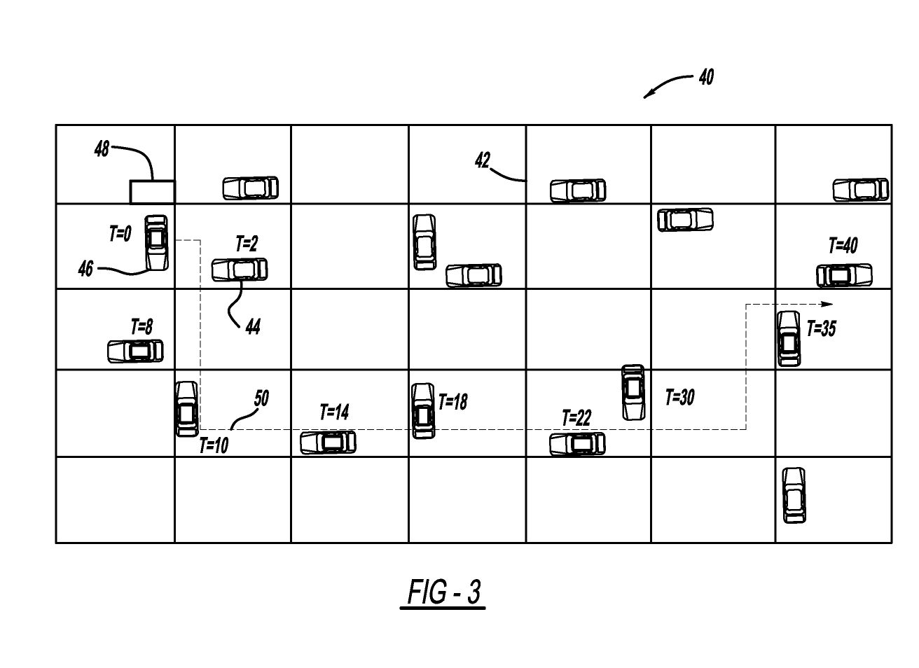

FIG. 3 is a plan view of a grid 40 of roadways 42 including vehicles 44 traveling thereon, similar to FIG. 2, illustrating the message distribution method discussed above, referred to as a peer-to-peer message distribution or delay-tolerant network message distributions. In the peer-to-peer messages distribution, a particular vehicle 46 directly receives an advertisement message from a business 48 and then keeps the message in its own cache. The vehicle 46 will periodically rebroadcast the advertisement message as it travels along a path 50 on the roadway 42 at certain time intervals T if all the predetermined conditions are met, such as the distance from the vehicle 46 to the business 48 is less than a predetermined distance, such as 5 km, and the current time is less than a predetermined message expiration time. All other vehicles 44 encountering the vehicle 46 will receive the advertisement message about the business 48 and will become a peer to further spread the message if they are interested. The peer-to-peer message distribution protocol is assisted by the inherent mobility of the vehicles.

Vehicles need to be activated to receive the specific messages in order for the message to be sent to the driver and/or be rebroadcast to other vehicles. For example, in the DSRC communications protocol, the message may be received at the system physical layer and then be sent to the network layer, and from there sent to an application layer in the communications system 12. However, if the vehicle 44 is not activated to receive and process the message concerning the businesses, then the application layer will discard those message packets of information without storing or processing them in the system 12. If, however, the vehicle 44 is activated to receive those types of messages, then the messages will be sent from the application layer into the buffers of the system 12 to be processed, and can be rebroadcast to other vehicles 44 within the temporal and spatial time constraints of the system 12. If the vehicle driver then wants to learn about a particular business 46, the vehicle driver can activate the system 12 so that the businesses 46 are displayed on a map on the display 20.

In another embodiment, a V2X in-network message generation distribution and processing protocol is a client-server message distribution protocol where a group of special vehicles have a dedicated capability and are equipped with larger storage and processors that serve as mobile servers of geo-service and advertisements and keep a list of local business directory information, where the vehicles are referred to as mobile directory service vehicles. These vehicles will act as the source of the message instead of the business itself so that when they are within some predetermined distance of the business, they will broadcast the messages concerning the location of the business to other vehicles. These vehicles will periodically rebroadcast geo-service advertisement lists to vehicles they encounter and these vehicles will receive a geo-service advertising list from the special mobile service vehicles either via a multi-hop message dissemination protocol or in a delay-tolerant network message distribution protocol.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for distributing advertising messages between and among vehicles, said method comprising:
broadcasting an advertising message from a business where the message identifies the business, the time of the transmission and a predetermined spatio-temporal range for the distribution of the message from the business;
receiving the message by a vehicle traveling within a certain distance of the business and within a predetermined time period of when the message was broadcast from the business;
retransmitting the message from the vehicle to be received by another vehicle within the predetermined range and within the predetermined time period; and
displaying the message to an occupant of a vehicle that receives the message within the predetermined range and within the predetermined time period of when the message was broadcast from the business.

2. The method according to claim 1 wherein the business is a restaurant.

3. The method according to claim 1 wherein retransmitting the message from the vehicle includes periodically retransmitting the message from the vehicle as long as the vehicle is within the predetermined range.

4. The method according to claim 1 wherein retransmitting the message from the vehicle includes retransmitting the message from the vehicle to other vehicles in a multi-hop manner so that the message is propagated to vehicles beyond the certain distance.

5. The method according to claim 1 wherein the predetermined range is 5 kilometers.

6. The method according to claim 1 wherein broadcasting advertising messages from a business includes using a dedicated short range communications transmitter.

7. The method according to claim 1 wherein the message includes a coupon providing some value as to goods sold by the business.

8. A method for distributing advertising messages between and among vehicles, said method comprising:
broadcasting an advertising message that identifies a business, a temporal constraint of the message and a predetermined spatio-temporal range for distribution of the message from the business;
receiving the message by a vehicle traveling within the predetermined range and within a predetermined time period of when the message was broadcast about the business; and
displaying the message to an occupant of a vehicle that receives the message so as to allow the occupant to know about the business.

9. The method according to claim 8 wherein broadcasting an advertising message includes broadcasting the advertising message from the business.

10. The method according to claim 8 wherein broadcasting the advertising message includes broadcasting the advertising message from a designated vehicle having processing and storage capacity for storing and broadcasting the message.

11. The method according to claim 8 further comprising retransmitting the message from a vehicle that receives the message to another vehicle.

12. The method according to claim 11 wherein retransmitting the message from the vehicle includes periodically retransmitting the message from the vehicle as long as the vehicle is within the predetermined range.

13. The method according to claim 11 wherein retransmitting the message from the vehicle includes retransmitting the message from the vehicle to other vehicles in a multi-hop manner.

14. The method according to claim 8 wherein the business is a restaurant.

15. The method according to claim 8 wherein broadcasting advertising messages from a business includes using a dedicated short range communications transmitter.

16. The method according to claim 8 wherein the message includes a coupon providing some value as to goods sold by the business.

17. A system for distributing advertising messages between and among vehicles, said system comprising:
means for broadcasting an advertising message from a business where the message identifies the business, the time of transmission and a predetermined spatio-temporal range for the distribution of the message from the business;
means for receiving a message by a vehicle traveling within a certain distance of the business and within a predetermined time period of when the message was broadcast from the business;
means for retransmitting the message from the vehicle to be received by another vehicle within the predetermined range and within the predetermined time period; and
means for displaying the message to an occupant of the vehicle that receives the message within the predetermined range and within the predetermined time period of when the message was broadcast from the business.

18. The system according to claim 17 wherein the means for retransmitting the message from the vehicle retransmits the message from the vehicle to other vehicles in a multi-hop manner so that the message is propagated to vehicles beyond the certain distance.

19. The system according to claim 17 wherein the means for retransmitting the message from the vehicle periodically retransmits the message from the vehicle as long as the vehicle is within the predetermined range and within the predetermined time period.

20. The system according to claim 17 wherein the message includes a coupon providing some value as to goods sold by the business.
